(19) United States
(12) Patent Application Publication
(10) Pub. No.: US 2013/0085734 A1
(43) Pub. Date: Apr. 4, 2013

(54) MODEL AND COMPUTER BASED COOLANT FLOW DIAGNOSTIC SYSTEM

(71) Applicants: Tenghua Tom Shieh, Ann Arbor, MI (US); Erich Benjamin Fiederlein, Ann Arbor, MI (US)

(72) Inventors: Tenghua Tom Shieh, Ann Arbor, MI (US); Erich Benjamin Fiederlein, Ann Arbor, MI (US)

(73) Assignee: Toyota Motor Engineering & Manufacturing North America, Inc., Erlanger, KY (US)

(21) Appl. No.: 13/251,344

(22) Filed: Oct. 3, 2011

(51) Int. Cl. G06F 17/50; G06G 7/57

(52) U.S. Cl. 703/8

(57) ABSTRACT

A model and computer based diagnostic method and system for automating a simulation process for a component, sub-system, and system of a vehicle engine relating particularly to coolant filling and draining. The method including the steps of creating a physical prototype and transparency of fluid passageways within the engine including the following elements: a radiator, a reservoir, a water jacket, a heater core, a heat exchanger, and other coolant system components thereby forming a complete cooling system within a vehicle engine. Geometry is then imported from the physical prototype to the computer automated design system including physics statistics and thermodynamics of each element. The method lastly includes the step of simulating fluid flow through the coolant system.

### FIELD OF THE INVENTION

The present invention relates generally to systems for determining coolant temperature, and more particularly, this invention relates to a model and computer based diagnostic system for determining fluid flow and temperature within an automotive vehicle engine.

### BACKGROUND OF THE INVENTION

Prototyping of automotive vehicle engine cooling systems is well known in the art. Specifically, physical prototyping of cooling systems for automobile vehicle engines is known. The drainability of an engine and vehicle thermal management systems rely on a physical prototype for testing and evaluation. Testing of the prototype system consists of rigorous analysis of fluid flow, drainage, filling, temperature, etc. The collection of air pockets in specific areas of the thermal management system is evaluated by using a plurality of transparent conduits to connect each respective element. The physical prototype commonly used is created in transparency to see what happens inside the conduits. However, the physical prototyping having transparent conduits does not accommodate a system when rotating parts are considered. Any rotating part within the system must also be considered to properly determine fill and thermal calculations. Accordingly, there exists a need in the art to provide a reliable means for accurately determining system characteristics of a thermal management system within an automobile vehicle engine.

### SUMMARY OF THE INVENTION

The present invention provides for a model and computer based diagnostic method and system for automating a simulation process for a component, sub-system, and system of a vehicle engine relating particularly to coolant filling and draining. The method including the steps of creating a physical prototype and transparency of fluid passageways within the engine including the following elements: a radiator, a reservoir, a water jacket, a heater core, a heat exchanger, and other coolant system components thereby forming a complete cooling system within a vehicle engine. Each of the elements is in fluid communication with one another. The method further includes the steps of assessing the elements of the physical system having rotating parts and determining fluid flow through the elements of the physical system having rotating parts. The data collected in that assessment is imported into a computer database. Geometry is then imported from the physical prototype to the computer automated design system including physics statistics and thermodynamics of each element including a radiator, a reservoir, a water jacket, a heater core, a heat exchanger, and other coolant system components thereby forming a complete fluid system. The method lastly includes the step of simulating fluid flow through the coolant system wherein the results of the computer simulation are displayed on a display screen.

### BRIEF DESCRIPTION OF THE DRAWINGS

FIG. 1 is an environmental view diagram of a portion of the physical coolant system;

FIG. 2 is a perspective view diagram of the complete vehicle coolant system;

FIG. 3 is a flowchart illustrating the methodology of the present invention;

FIG. 4 is a focused diagram of the elements as shown in FIG. 2;

FIG. 5 is a graphical representation of the volume of coolant within the coolant system;

FIG. 6 is a graphical representation of the volume of the coolant spilled; and

FIG. 7 is a flowchart illustrating the steps required for the method of the present invention.

### DETAILED DESCRIPTION OF THE DRAWINGS

The present invention relates to a computer based diagnostic method for automating the simulation process to simulate a coolant system. The simulation process is used in connection with a plurality of components, sub-systems, and systems of a vehicle engine relating particularly to coolant filling and draining. The basic method including the general steps of creating a physical prototype in transparency including all essential elements to the cooling system, assessing the elements of the physical system having any rotating parts, importing the geometry of the physical prototype including all rotating elements into a database computer automated design system, allowing the database to simulate the fluid flow through the coolant system within the computer automated design.

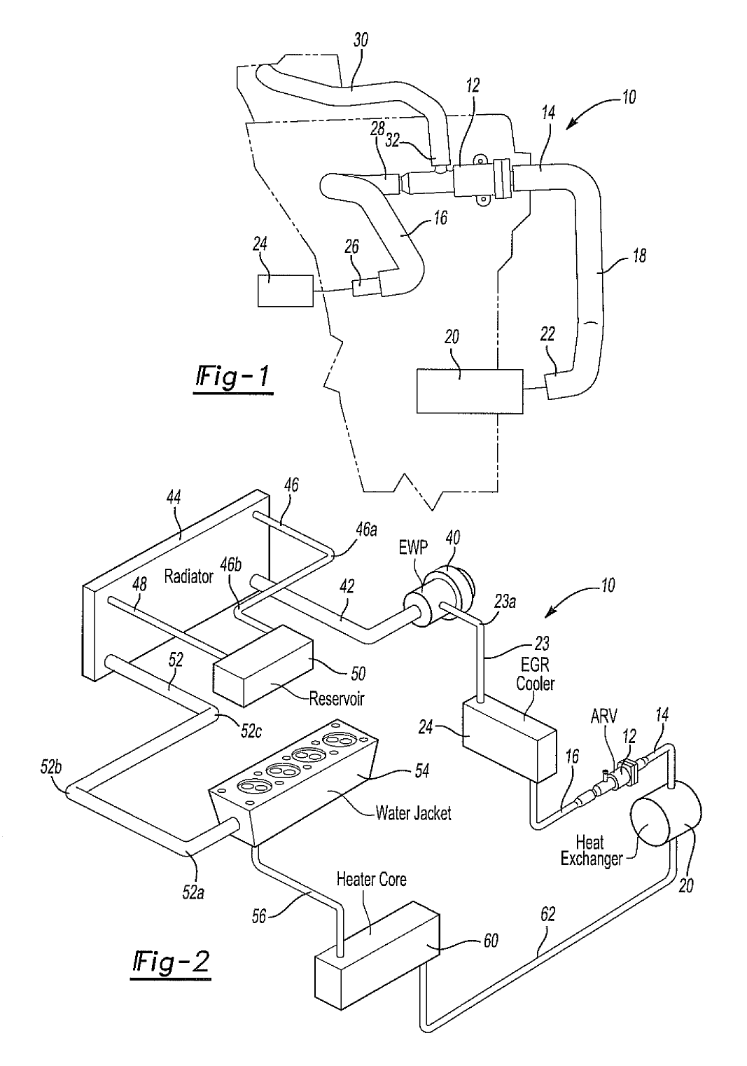

FIG. 1 illustrates an environmental view sectioned portion of a portion of the coolant system. The coolant system 10 is shown in FIG. 1 with a check valve 12, a heat exchanger 20, and an Exhaust Gas Recirculation Cooler (hereinafter EGR Cooler) 24. The check valve 12 connects to the heat exchanger 20 by means of a transparent conduit 18 having a first end 14 and a second end 22. The first end 14 of the conduit 18 connects to the check valve 12. The second end 22 of the conduit 18 connects to the heat exchanger 20. The conduit 30 having a first end 32 connects to the check valve 12. In one embodiment, the conduit 30 is transparent. The conduit 30 attaches to the check valve 12 connects to an oil separator (not shown). The conduit 16 connects the EGR Cooler 24 to the check valve 12. The conduit 16 includes a first end 26 and a second end 28. The first end 26 of the conduit 16 connects to the EGR Cooler 24. The second end 28 of the conduit 16 connects to the check valve 12. In the present embodiment, the conduit 16 is transparent allowing the user of the physical system to view the internal workings of the overall coolant system 10.

FIG. 2 illustrates the entire engine coolant system as connected by a plurality of conduits. The heat exchanger 20 is connected to the heater core 60 by means of the conduit 62. The heater core 60 is connected to the water jacket 54 by means of conduit 56. The water jacket 54 is connected to the radiator 44 by means of the conduit 52. In the present embodiment, the conduit 52 includes a plurality of 90 degree bends shown at 52a, 52b, 52c. The conduits 62, 56, 52, in this embodiment, are all transparent to allow the user to view the inner workings of the system 10. The transparent conduit 62, 56, 52 allows the user to view any air bubbles or inconsistencies within the conduit 62, 56, 52.

A reservoir 50 is operable to store excess fluid. The reservoir connects to the radiator 44 by means of a first conduit 46 and a second conduit 48. The first conduit 46 is transparent and includes a plurality of 90 degree bends 46a and 46b. The second conduit 48 is also transparent. The radiator 44 further connects to the Electric Water Pump or EWP 40 by means of the transparent conduit 42. The EWP 40 connects to the EGR Cooler 24 by means of the conduit 23 having a first 90 degree bend 23a. And again, as previously discussed, the EGR Cooler 24 connects to the check valve (Air Relief Valve herinafter ARV) 12 by means of the conduit 16. All of the elements discussed above are in fluid communication with one another. In the present embodiments, all conduits connecting the elements as described above are transparent to allow the user to view the inner workings of the system. In an alternative embodiment, the elements such as the heater core 60, water jacket 54, reservoir 50, radiator 44, EWP 40, EGR Cooler 24, Air Relief Valve or ARV 12, and heat exchanger 20 are also transparent or at least partially transparent to allow the user to view the fluid passing through the system. The user is allowed to view the inner system workings to view air bubbles or other inconsistencies within the fluid.

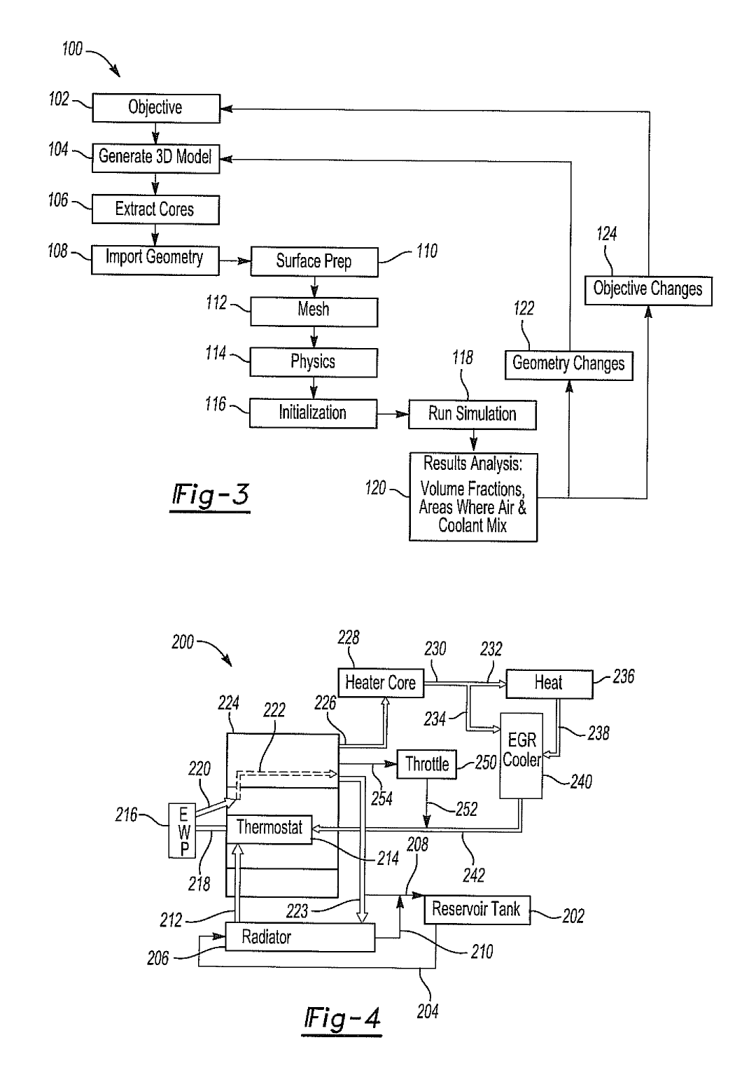

FIG. 3 illustrates a methodology for the present invention. The methodology 100 includes the steps of determining an objective 102, generating a 3D model 104, extracting cores 106, and importing geometry 108. The method 100 further includes the steps of surface preparation 110, meshing 112, physics 114, and initialization 116. The method goes on to further include the steps of running the simulation 118 and conducting results analysis 120 including analyzing the volume fractions and areas where the air and coolant are mixed. The method 100 then includes implementing geometry changes 122 and proceeding to regenerate a 3D model 104. Alternatively, the user may make objective changes 124 and restart the system at determining an objective 102 wherein the user will then proceed accordingly on to generating a 3D model 104.

FIG. 4 illustrates the system of the present invention in 2D format. The system 200 is illustrated having a reservoir tank 200 connected to a radiator 206 by means of the conduit 204. The radiator also connects to the reservoir tank 202 by means of a second conduit 210. The radiator 206 then connects to a thermostat 214 by means of a connector 212. The thermostat then connects to the EWP 216 by means of the connector 218. The EWP 216 connects by a plurality of conduits 220, 222, 233 back to the radiator 206. The base 224 connects to the heater core 228 by means of the connector 226. The base 224 further connects to the throttle 250 by means of the connector 254. The throttle 250 connects to the thermostat 214 by means of the connector 242. The heater core connects to the heat exchanger 236 by means of the conduit 230, 232. The heat exchanger 236 connects to the EGR Cooler 240 by means of the conduit 238.

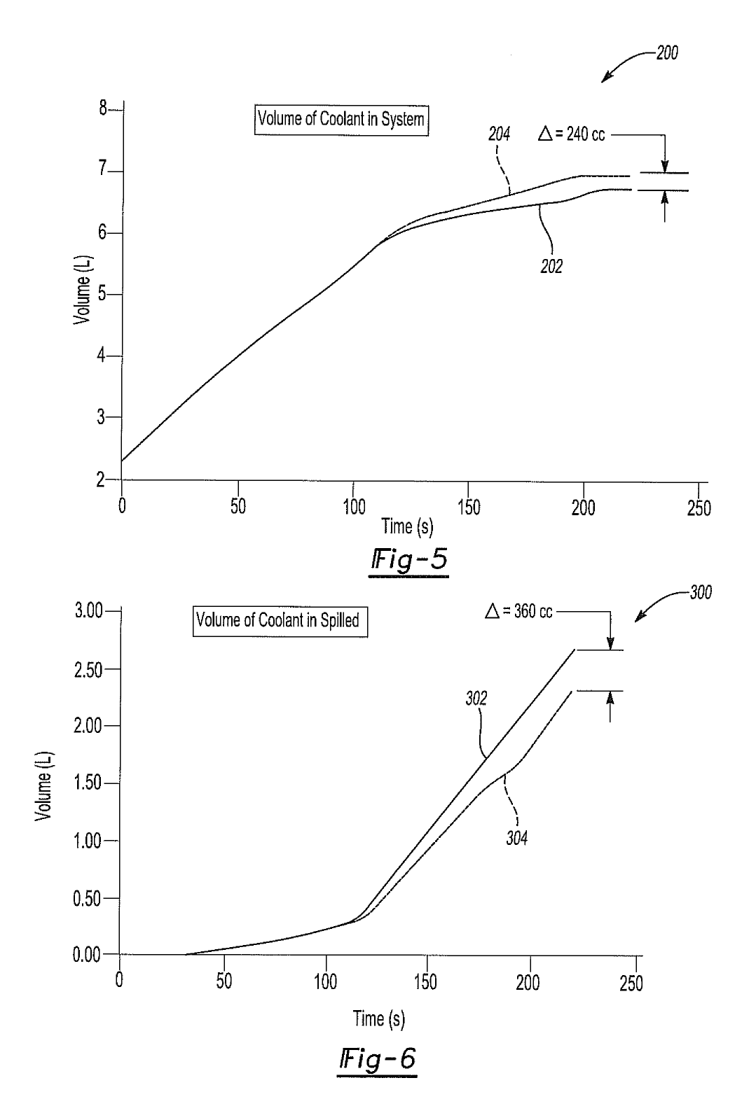

The graphs as depicted in FIGS. 5 and 6 illustrate the volume of the coolant in the system (FIG. 5) and the volume of the coolant spilled (FIG. 6). First graph 200 illustrates the line 202 in simulation number 1 and the line 204 in simulation number 2. Furthermore, FIG. 6 depicts graphical representation 300 having a first line 302 and a second line 304 showing a significant change in coolant spilled.

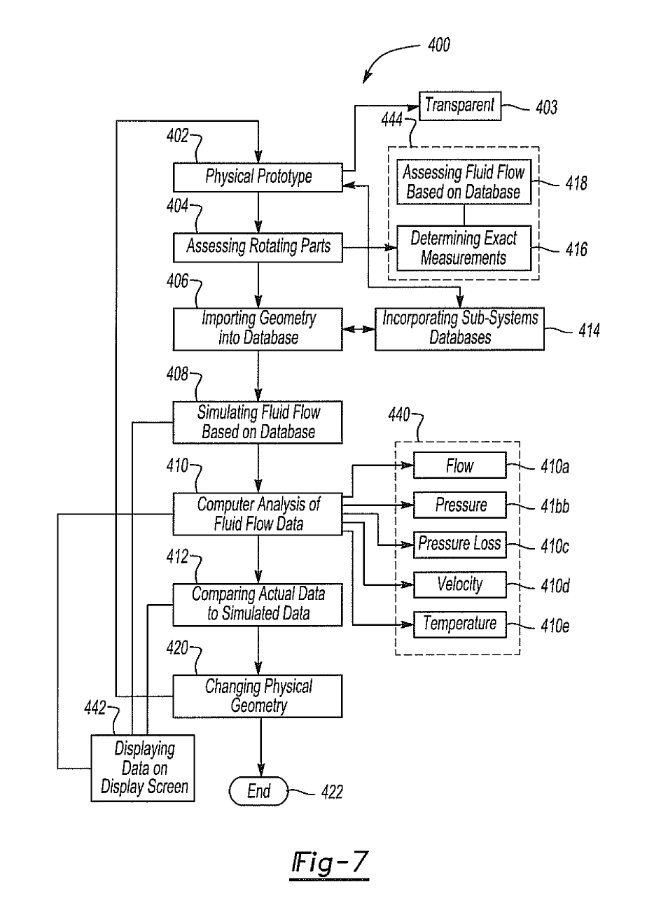

FIG. 7 illustrates the method 400 of developing a model and computer based diagnostic method. The model and computer based diagnostic method 400 for automating a simulation process for a component, sub-system, and system of a vehicle engine relating particularly to coolant filling and draining includes the steps of creating a physical prototype 402 in transparency 403 of the fluid passageways within the engine including the elements of a radiator, reservoir, water jacket, heater core, heat exchanger, and other coolant system components thereby forming a complete coolant system. Each of the elements is in fluid communication. The method 400 then includes the step of assessing rotating parts 404 by assessing fluid flow 414 and determining exact measurements 416. The exact measurements 416 and assessment of fluid flow 418 producing computer based information available in a database 444. The database 444 is in constant communication with the computer design system and is updated by computer means. Data is extracted from various computer assessments and analysis and imported into the database 444.

The method 400 then includes the step of importing geometry 406 into a computer based design system. Importing the geometry 406 of the physical prototype 402 to the computer automated design system includes importing physics statistics of each element including a radiator, reservoir, water jacket, heater core, heat exchanger, and other coolant system components thereby forming a complete coolant system. The method 400 then includes the step of simulating fluid flow 408 in a computer based design system such as CAD. The computer simulated fluid flow from step 408 is then displayed on a computer based display screen 442.

The method 400 then includes the step of analyzing fluid flow data 410. Analysis 410 includes analyzing flow 410a, pressure 410b, pressure loss 410c, velocity 410d, and temperature 410e. The computer analysis as in step 410 is then displayed on the display screen 442. The computer analysis of fluid flow data 410 is electronically stored in a database 440. The automatic commuter analysis 410 of the flow 410a, pressure 410b, pressure loss 410c, velocity 410d and temperature 410e produces data which is automatically stored in the database 440. The database 440 is in communication with the computer design system of the present invention.

The next step in the method 400 includes the step of comparing actual data to simulated data 412. The data from the database compared at step 412 is then displayed on the display screen 422. The method 400 then includes the step of changing physical geometry 420 to best optimize the overall system. If geometry is changed at step 420, the user then recreates a physical prototype 402 and proceeds to the next step of assessing rotating parts 404 and proceeds on through the following steps 406-422. If the user is satisfied during the method 400 after step 420 (changing physical geometry), then the user may end 422 the method and process.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A computer based diagnostic method for automating a simulation process for a component, sub-system and system of a vehicle engine relating to coolant filling and draining, the method comprising the steps of
creating a physical prototype in transparency of the fluid passageways with the engine including a plurality of elements;
determining fluid flow through the elements of the physical system having rotating parts, incorporating fluid flow data into a computer database;
import geometry of physical prototype to computer database, importing geometry from the computer database into a computer automated design system including physics statistics of the plurality of elements; and
simulating fluid flow through the coolant system using the computer database and computer automated design system; combining geometry information contained within the database in the computer based drafting software, the computer based design system displaying the simulation on a screen.

2. The method as described in claim I wherein the method further includes the steps of computer based analysis of the fluid flow data output from the simulation process.

3. The method as described in claim 2 wherein analyzing the fluid flow data output includes computer based analysis of flow, pressure, pressure loss, velocity and temperature.

4. The method as described in claim 3 wherein the simulated data is compared to the physical data as retrieved from the physical prototype in the computer automated design system.

5. The method as described in claim 1 wherein the method further includes the steps of incorporating sub-systems into the prototype in the computer automated design system.

6. The method as described in claim 1 wherein the method further includes the steps of incorporating sub-systems into the computer automated design.

7. The method as described in claim 1 wherein the method further includes the steps of creating a database within the computer automated design system having exact measurements of each element of the prototype.

8. The method as described in claim 7 wherein the method further includes creating a database within the computer automated design system having fluid flow characteristics of the elements having rotating parts.

9. The method as described in claim 1 wherein the physical prototype having a plurality of elements in fluid connection are connected by transparent tubing.

10. The method as described in claim 1 where the elements of the physical prototype are transparent allowing the user to view any air pockets during the filling and/or draining process.

11. The method as described in claim 1 further including the steps of implementing physical geometry changes on the computer automated design system.

12. The method as described in claim 14 further including the step of running the simulation process in the computer automated design system including the physical geometry changes.

13. The method as described in claim 1 wherein the plurality of elements includes a radiator, a reservoir, a water jacket, a heater core, a heat exchanger and other coolant system elements.
